(19) United States
(12) Patent Application Publication
(10) Pub. No.: US 2019/0303806 A1
(43) Pub. Date: Oct. 3, 2019

(54) BOARDING MANAGEMENT SYSTEM, BOARDING MANAGEMENT METHOD, AND SYSTEM

(71) Applicant: PANASONIC INTELLECTUAL PROPERTY MANAGEMENT CO., LTD., Osaka (JP)

(72) Inventors: Ryohei NAMBA, Osaka (JP); Tomoaki TANAKA, Osaka (JP)

(73) Assignee: PANASONIC INTELLECTUAL PROPERTY MANAGEMENT CO., LTD., Osaka (JP)

(21) Appl. No.: 16/364,950

(22) Filed: Mar. 26, 2019

(30) Foreign Application Priority Data
Mar. 29, 2018 (JP) 2018-066181

(51) Int. Cl. G06Q 10/02; G08G 1/127; G01C 21/34; G06Q 50/30

(52) U.S. Cl. CPC G06Q 10/02; G06Q 50/30; G01C 21/3438; G08G 1/127

(57) ABSTRACT

A boarding management system according to the present disclosure determines a first time when a moving vehicle is expected to arrive at a boarding location and a second time when a scheduled passenger is expected to arrive at the boarding location. A time lag between the first time and the second time is determined. Depending on the time lag between the first time and the second time, the boarding management device decides whether or not to perform cancellation processing of canceling a boarding reservation, made for the scheduled passenger, of the moving vehicle. The cancellation processing of canceling the boarding reservation is performed in accordance with a decision to perform the cancellation processing.

### TECHNICAL FIELD

The present disclosure generally relates to a boarding management system, a boarding management method, and a moving vehicle, and more particularly relates to a boarding management system, a boarding management method, and a moving vehicle, all of which are configured or designed to make boarding management of a moving vehicle which may be used by a plurality of users.

### BACKGROUND ART

A transportation system designed to run vehicles (moving vehicles) has been known in the art (see, for example, Japanese Unexamined Patent Application Publication No. 2001-229495 (hereinafter referred to as “D1”)). The transportation system of D1 includes a reservation acceptance and allocation center for accepting multiple pieces of service reservations information entered by a plurality of users. When finding, in accordance with the multiple pieces of service reservations information, that the same vehicle can be dispatched to a plurality of users, the reservation acceptance and allocation center searches for the best running route for the same vehicle and provides those users with reservation acceptance information including a vehicle boarding location and an estimated time of arrival (ETA).

### SUMMARY

The present disclosure provides a boarding management system, a boarding management method, and a moving vehicle, all of which are configured or designed to provide improved convenience for users.

A boarding management system according to an aspect of the present disclosure includes at least one processor and at least one memory. The at least one memory includes a set of instructions that cause, when executed by the at least one processor, the at least one processor to perform operations including: determining, based on a first set of information, a first time when a moving vehicle is expected to arrive at a boarding location; determining, based on a second set of information, a second time when a scheduled passenger is expected to arrive at the boarding location; determining a time lag between the first time and the second time; deciding, depending on the time lag between the first time and the second time, whether or not to perform cancellation processing of canceling a boarding reservation, made for the scheduled passenger, of the moving vehicle; and performing the cancellation processing of canceling the boarding reservation in accordance with a decision made by the at least one processor to perform the cancellation processing.

A boarding management method according to another aspect of the present disclosure includes: determining, based on a first set of information, a first time when a moving vehicle is expected to arrive at a boarding location; determining, based on a second set of information, a second time when a scheduled passenger is expected to arrive at the boarding location; determining a time lag between the first time and the second time; deciding, using at least one processor and depending on the time lag between the first time and the second time, whether or not to perform cancellation processing of canceling a boarding reservation, made for the scheduled passenger, of the moving vehicle; and performing the cancellation processing of canceling the boarding reservation in accordance with a decision made by the at least one processor to perform the cancellation processing.

A system according to still another aspect of the present disclosure includes: the boarding management system described above; and at least one moving vehicle. The at least one moving vehicle includes: a communications module configured to communicate with the boarding management system described above; and at least one processor configured to perform processing in accordance with driving instruction information received from the boarding management system via the communications module.

### BRIEF DESCRIPTION OF DRAWINGS

FIG. 1 is a block diagram of an overall system including a boarding management system according to an embodiment of the present disclosure;

FIG. 2 illustrates how the boarding management system performs push notification processing;

FIG. 3 is a flowchart showing a procedure in which the boarding management system performs the push notification processing;

FIG. 4 illustrates how the boarding management system performs the push notification processing;

FIG. 5 is a flowchart showing a procedure in which the boarding management system performs reservation cancellation processing;

FIG. 6 is a flowchart showing a procedure in which the boarding management system performs first time calculation processing; and

FIG. 7 is a flowchart showing a procedure in which the boarding management system performs second time calculation processing.

### DESCRIPTION OF EMBODIMENTS

### Embodiment

### (1) Overview

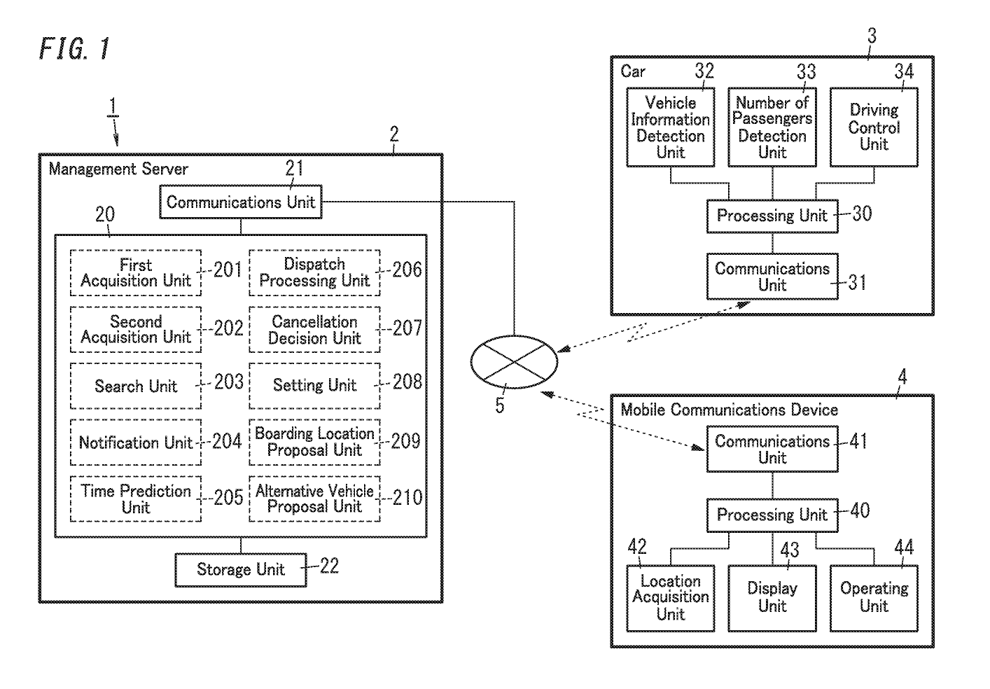

FIG. 1 is a block diagram of an overall system including a boarding management system 1 according to an exemplary embodiment of the present disclosure.

The boarding management system 1 according to this embodiment is applicable to, for example, ride sharing services provided by a taxi business operator who manages allocation of a plurality of moving vehicles (taxis). Such ride sharing services allow a plurality of users (either multiple persons or multiple groups of people) to share a single moving vehicle (taxi), and also allows each of the plurality of users to specify where he or she wants to get out. Also, the plurality of users may board the moving vehicle at multiple different locations and each of the plurality of users may also specify where he or she wants to board. That is to say, the route of the moving vehicle is not determined in advance, and the scheduled route of the moving vehicle is changed into an optimized one depending on where the user of the moving vehicle wants to get in and get out. The moving vehicle does not have to be a car for business use, the allocation of which is managed by a transportation service operator such as a taxi business operator, but may also be a car privately owned by a user who is registered with a business operator providing ride sharing services. As used herein, the “moving vehicle” refers to any type of vehicle that can be used by a plurality of users (or passengers). Examples of the moving vehicles include cars, railway trains, ships, and aircrafts. The “boarding location” refers herein to a location where the user boards the moving vehicle. The “deboarding location” refers herein to a location where the user gets out of the moving vehicle.

The boarding management system 1 according to this embodiment has the capability of automatically canceling a boarding reservation, made by a user (hereinafter referred to as a “scheduled passenger”), for the moving vehicle 3.

The boarding management system 1 includes a cancellation decision unit 207. The cancellation decision unit 207 decides, depending on a time lag between a first time and a second time, whether or not to perform cancellation processing of canceling a boarding reservation, made by a scheduled passenger, for a moving vehicle (such as a car 3). The first time is a time when the moving vehicle (such as the car 3) is expected to arrive at a boarding location. The second time is a time when the scheduled passenger is going to arrive at the boarding location.

The moving vehicle (car 3) according to this embodiment includes a communications unit 31 (i.e. a communications module) and a processing unit 30. The communications unit 31 communicates with the boarding management system 1. The processing unit 30 performs processing in accordance with driving instruction information received from the boarding management system 1 via the communications unit 31.

Known transportation systems are not convenient enough for all users, because a user who has once reserved a vehicle (a scheduled passenger) but who wants to cancel his or her reservation has to do the canceling operation by him- or herself. In addition, if a user who has reserved a vehicle is certainly heading toward the vehicle boarding location but is unable to arrive at the location by the estimated time of arrival, then the reserved vehicle has to wait for the user who has reserved the vehicle to arrive at the boarding location, unless the user performs the operation of canceling the reservation. This causes a significant decline in the convenience of the vehicle for the other users who have already been aboard their reserved vehicle.

Thus, to overcome such a problem, in the boarding management system 1 according to this embodiment, the cancellation decision unit 207 decides, depending on the time lag between the first time and the second time, whether or not to perform the cancellation processing of canceling a boarding reservation, made by the scheduled passenger, for the moving vehicle. This saves the scheduled passenger the trouble to cancel his or her reservation by him- or herself, thus providing a boarding management system 1 with improved user friendliness and convenience.

### (2) Details

(2.1) Configuration

As shown in FIG. 1, the boarding management system 1 of this embodiment includes a management server 2 for managing ride sharing of a plurality of cars 3.

The overall system including the boarding management system 1 includes the management server 2 included in the boarding management system 1, a plurality of cars 3, each of which may be shared by a plurality of users (either a plurality of persons or multiple groups of people), and mobile communications devices 4 carried by the users with them.

(2.2.1) Configuration of Cars

Each of the cars 3 may be implemented as a self-driving car (also called an “autonomous car”), of which the operation is managed by the management server 2.

The car 3 includes the processing unit 30, the communications unit 31, a vehicle information detection unit 32, a number of passengers detection unit 33, and a driving control unit 34.

The communications unit 31 has a communication capability of establishing wireless communication via radio waves, for example, and communicates with the management server 2 over a communications network 5 including a mobile communications network.

The vehicle information detection unit 32 detects vehicle information about the condition of the car 3. The vehicle information detection unit 32 acquires (or detects) various pieces of information about the speed, traveling direction, destination, and scheduled route of the car 3 from an electronic control unit (ECU), which is designed to control respective parts of the car 3, for example. In addition, the vehicle information detection unit 32 also acquires information about the current location of the car 3 using, for example, a positioning system such as a global positioning system (GPS).

The number of passengers detection unit 33 detects the number of passengers (or users) who are riding to share the car 3. For example, the number of passengers detection unit 33 may include a seat sensor provided for each seat of the car 3 and detect, based on the result of detection of the seat sensors, the number of passengers who are currently seated on the seats. Optionally, the number of passengers detection unit 33 may also include an image sensor for shooting the vehicle cabin of the car 3 to detect, based on the image shot by the image sensor, the number of passengers who are riding the car 3.

The driving control unit 34 may include an ECU for controlling respective parts of the car 3, for example. The driving control unit 34 may control, in accordance with a control instruction given by the processing unit 30 and results of detection of respective sensors provided for the car 3, the driving condition of the car 3. The sensors are detecting the situation surrounding the car 3. Examples of this type of sensors include light detection and ranging (Lidar) sensors and milliwave radars.

The processing unit 30 may be implemented, for example, as a microcomputer including at least one processor and at least one memory. That is to say, the processing unit 30 is implemented as a computer system including the at least one processor and the at least one memory. In other words, the computer system performs the functions of the processing unit 30 by making the at least one processor execute a predetermined program. The program may be stored in advance in the memory or may also be downloaded via a telecommunications line such as the Internet or distributed after having been stored on a non-transitory storage medium such as a memory card.

The processing unit 30 makes the communications unit 31 transmit the results of detection obtained by the vehicle information detection unit 32 and number of passengers detection unit 33 to the management server 2 at regular intervals (of, e.g., a few minutes). Alternatively, the processing unit 30 may also make the communications unit 31 transmit the results of detection obtained by the vehicle information detection unit 32 and number of passengers detection unit 33 to the management server 2 at irregular intervals. The processing unit 30 may make the communications unit 31 transmit the results of detection obtained by the vehicle information detection unit 32 and number of passengers detection unit 33 to the management server 2 upon a request from the management server 2. Furthermore, upon receiving the driving instruction information from the management server 2 via the communications unit 31, the processing unit 30 outputs a control signal to the driving control unit 34 to make the driving control unit 34 to drive the car 3 autonomously to the destination. That is to say, the processing unit 30 performs processing in accordance with the driving instruction information received from the management server 2 via the communications unit 31. In this embodiment, examples of the driving instruction information from the management server 2 include the destination, an estimated time of arrival at the destination, one or more stops (such as the boarding and deboarding locations of one or more users) to the destination, and estimated times of arrival at the stops. The processing performed in accordance with the driving instruction information refers herein to the processing performed by the processing unit 30 to drive the car 3 by controlling the driving control unit 34 in accordance with the driving instruction information. However, the processing performed in accordance with the driving instruction information does not have to be the processing of driving the car 3 autonomously.

Note that the car 3 does not have to be such an autonomous car. Alternatively, the car 3 may also be a car driven manually by a driver in accordance with the driving instruction information given by the management server 2. In this case, the processing performed by the processing unit 30 in accordance with the driving instruction information may be processing of notifying the driver of a scheduled route and other pieces of information in accordance with the driving instruction information.

(2.1.2) Configuration of Mobile Communications Device

The mobile communications device 4 may be implemented, for example, as a smartphone carried by each user (who may be either a potential user or a scheduled passenger) of this boarding management system 1. As used herein, the “potential user” refers to a user who is currently not using, but may potentially use, the car 3 to be shared by multiple persons. On the other hand, the “scheduled passenger” refers to a person who is currently not using, but has made a boarding reservation for, the car 3 to be shared by multiple persons.

The mobile communications device 4 includes a processing unit 40, a communications unit 41, a location acquisition unit 42, a display unit 43, and an operating unit 44.

The processing unit 40 may be implemented, for example, as a microcomputer including a processor and a memory. That is to say, the processing unit 40 is implemented as a computer system including a processor and a memory. In other words, the computer system performs the functions of the processing unit 40 by making the processor execute a predetermined program. The program may be stored in advance in the memory or may also be downloaded via a telecommunications line such as the Internet or distributed after having been stored on a non-transitory storage medium such as a memory card.

The communications unit 41 has a communication capability of establishing wireless communication via radio waves, for example, and communicates with the management server 2 over the communications network 5 including a mobile communications network.

The location acquisition unit 42 acquires location information about the current location of the mobile communications device 4, i.e., the current location of the user carrying the mobile communications device 4 with him or her, by using a positioning system such as a global positioning system (GPS).

The display unit 43 may be implemented as some type of display such as a liquid crystal display or an organic electroluminescent (EL) display. The display unit 43 presents, in the form of characters, figures, or signs, the notification information transmitted from the management server 2.

The operating unit 44 includes a touchscreen panel provided for the display unit 43 and an operating button provided for the body of the mobile communications device 4 to accept commands entered by the user.

Note that the mobile communications device 4 does not have to be implemented as a smartphone but may also be a tablet mobile communications device with communication capability.

(2.1.3) Configuration of Management Server

The management server 2 includes a processing unit 20, a communications unit 21 (i.e. a communications module), and a storage unit 22.

The processing unit 20 may be implemented, for example, as a microcomputer including at least one processor and at least one memory. That is to say, the processing unit 20 is implemented as a computer system including the at least one processor and the at least one memory. The at least one memory include a set of instructions that cause, when executed by the at least one processor, the at least one processor to perform predetermined operations. In other words, the computer system performs the functions of the processing unit 20 by making the at least one processor execute a predetermined program. The program may be stored in advance in the memory or may also be downloaded via a telecommunications line such as the Internet or distributed after having been stored on a non-transitory storage medium such as a memory card.

The processing unit 20 of this embodiment has the function of the cancellation decision unit 207.

The cancellation decision unit 207 decides, depending on a time lag, predicted by the time prediction unit 205 (to be described later), between a first time and a second time, whether or not to perform cancellation processing of canceling a boarding reservation made by a scheduled passenger. The first time is a time when the car 3 is expected to arrive at the boarding location of the scheduled passenger. The second time is a time when the scheduled passenger is going to arrive at the boarding location. For example, if the time lag between the first time and the second time is greater than a threshold value (i.e., when either the car 3 or the scheduled passenger that has arrived at the boarding location earlier is expected to have a waiting time greater than the threshold value), the cancellation decision unit 207 performs the cancellation processing of canceling the boarding reservation made by the scheduled passenger.

In addition, the processing unit 20 of this embodiment may further have the functions of a first acquisition unit 201, a second acquisition unit 202, a search unit 203, a notification unit 204, a time prediction unit 205, an dispatch processing unit 206, a setting unit 208, a boarding location proposal unit 209, and an alternative vehicle proposal unit 210. Note that the processing unit 20 does not have to have all of these functions of the first acquisition unit 201, second acquisition unit 202, search unit 203, notification unit 204, time prediction unit 205, dispatch processing unit 206, setting unit 208, boarding location proposal unit 209, and alternative vehicle proposal unit 210, some of which may be omitted as appropriate.

The first acquisition unit 201 acquires a first set of information about the condition of the car 3 from the car 3 via the communications unit 21. The first acquisition unit 201 also acquires, as another piece of the first set of information, driving instruction information including scheduled route information about the scheduled route of the car 3, from the storage unit 22. The first set of information includes pieces of information about the condition of the car 3. The first set of information includes at least one piece of information selected from the group consisting of information about the current location of the car 3, information about the speed of the car 3, information about the destination of the car 3, scheduled route information about the scheduled route of the car 3, and information about the number of users. As used herein, information about the number of users is information about the number of users of the car 3. The number of users is the sum of the number of passengers already riding the car 3 and the number of users who are going to get in the car 3.

The second acquisition unit 202 acquires, from the mobile communications device 4 via the communications unit 21, a second set of information about the activity status of each user carrying the mobile communications device 4 (who may be a potential user or a scheduled passenger). The second set of information may be information about the activity status of the user. The second set of information includes, as pieces of information about the user's activity status, at least one piece of information selected from the group consisting of location information about the user's current location or condition information about the user's current condition. Specifically, the location information may be information about the coordinates of the user's current location or the name of the place or building where the user is currently in. The condition information is information about the current condition (such as traveling, resting, or working) of the user's. The condition information may also include information about the current traveling speed and traveling direction of the user. Optionally, the second acquisition unit 202 may acquire (presume), based on the location information and the condition information, predicted activity information about results of prediction of the user's upcoming activity. The predicted activity information is information about the results of prediction of the user's upcoming activity based on the location, traveling velocity and other parameters of the user over a predetermined period of time up to the present, and may include, for example, information about the user's traveling route and information about the user's destination. That is to say, the second set of information may include, as pieces of information about the user's activity status, at least one piece of information selected from the group consisting of location information about the user's current location, condition information about the user's current condition, and information about the user's upcoming activity predicted.

The search unit 203 performs the search processing of searching, based on the first set of information acquired by the first acquisition unit 201 and the second set of information acquired by the second acquisition unit 202, for a recommended candidate, which is recommendable for the potential user, from among a plurality of cars 3.

The notification unit 204 notifies the potential user of the search results obtained by the search unit 203. Specifically, the notification unit 204 has the search results obtained by the search unit 203 transmitted to the potential user's mobile communications device 4 via the communications unit 21. Also, if the cancellation decision unit 207 decides to cancel the boarding reservation made by the scheduled passenger, the notification unit 204 may have a notification of cancellation, indicating that the boarding reservation has been canceled, transmitted to the scheduled passenger's mobile communications device 4 via the communications unit 21. Optionally, the notification unit 204 may also notify the user (who may be a potential user or a scheduled passenger) of any of various sorts of information other than the search results obtained by the search unit 203 and the notification of cancellation of the boarding reservation.

The time prediction unit 205 predicts, based on the first set of information acquired by the first acquisition unit 201 and other pieces of information, a first time when the car 3 is expected to arrive at the scheduled passenger's boarding location. In addition, the time prediction unit 205 also predicts, based on the second set of information acquired by the second acquisition unit 202 and other pieces of information, a second time when the scheduled passenger is going to arrive at the boarding location. For example, the time prediction unit 205 (prediction unit) may predict the second time based on at least information, included in the second set of information, about the scheduled passenger's current location.

The dispatch processing unit 206 may have, in accordance with reservation information and other pieces of information received from the user's mobile communications device 4 via the communications unit 21, driving instruction information, indicating that the car 3 be dispatched to the user's boarding location, transmitted to the car 3 via the communications unit 21.

The setting unit 208 sets threshold values for allowing the cancellation decision unit 207 to decide whether or not to cancel the boarding reservation. The setting unit 208 sets the threshold values such that a second threshold value for a second situation where the car 3 is expected to arrive at the boarding location earlier than the scheduled passenger becomes different from a first threshold value for a first situation where the scheduled passenger is expected to arrive at the boarding location earlier than the car 3. In a situation where the car 3 that the scheduled passenger is scheduled to board is used by other users, the longer the car 3 has to wait at the boarding location, the longer the other users will have to wait there. Thus, the setting unit 208 sets the threshold value for the situation where the car 3 arrives at the boarding location earlier than the scheduled passenger at a value less than the threshold value for the situation where the scheduled passenger arrives at the boarding location earlier than the car 3. The setting unit 208 accepts data entered by the user of the management server 2 (who may be an administrator of the ride sharing services), for example, and sets threshold values in accordance with the data entered.

If the cancellation decision unit 207 performs the cancellation processing of canceling the boarding reservation, the boarding location proposal unit 209 performs the processing of proposing an alternative boarding location to the scheduled passenger. The boarding location proposal unit 209 may have information indicating the alternative boarding location transmitted to the scheduled passenger's mobile communications device 4 via the communications unit 21.

If the cancellation decision unit 207 performs the cancellation processing of canceling the boarding reservation, the alternative vehicle proposal unit 210 performs the processing of proposing an alternative car 3 available for the scheduled passenger. The alternative vehicle proposal unit 210 may have information indicating the alternative car 3 and information about the boarding location transmitted to the scheduled passenger's mobile communications device 4 via the communications unit 21.

The communications unit 21 may include, for example, a communications module compliant with the Ethernet® standard and communicate with the car 3 and the mobile communications device 4 over the communications network 5.

The storage unit 22 may include an external storage device such as a hard disk drive (HDD) or a solid state drive (SSD). The storage unit 22 stores the contact information (such as the phone numbers, email addresses, and IP addresses) of the mobile communications devices 4 carried by the users of the boarding management system 1. In addition, the storage unit 22 also stores the contact information (such as IP addresses identifying the respective communications units 31 of the cars 3) of the plurality of cars 3, of which the operation is managed by the boarding management system 1. Besides, the storage unit 22 further stores the first set of information acquired from the plurality of cars 3, the driving instruction information provided for the plurality of cars 3, the second set of information acquired from the mobile communications devices 4, and map information of the area where the boarding management system 1 provides the ride sharing services.

(2.2) Operation

Next, it will be described how the boarding management system 1 of this embodiment operates. In the following description, it will be described how the boarding management system 1 performs push notification processing to propose an available car 3 as a recommended candidate to the potential user and reservation cancellation processing of canceling the boarding reservation, made by the scheduled passenger, for the car 3.

(2.2.1) Push Notification Processing

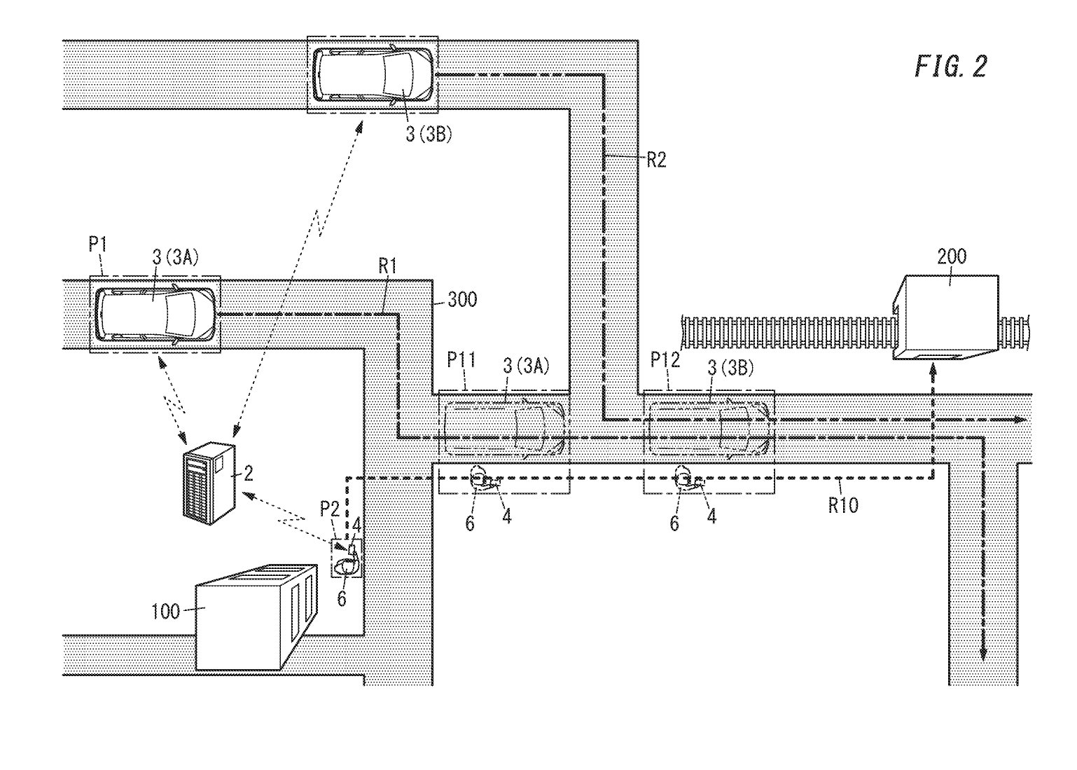

Now, it will be described with reference to FIGS. 2 to 4 how the boarding management system 1 performs the push notification processing.

In the following example, it will be described how the management server 2 makes push notification to the potential user 6 who is registered with the management server 2 of the boarding management system 1 and who is on the way home by walking from his or her office 100 toward the nearest railway station 200.

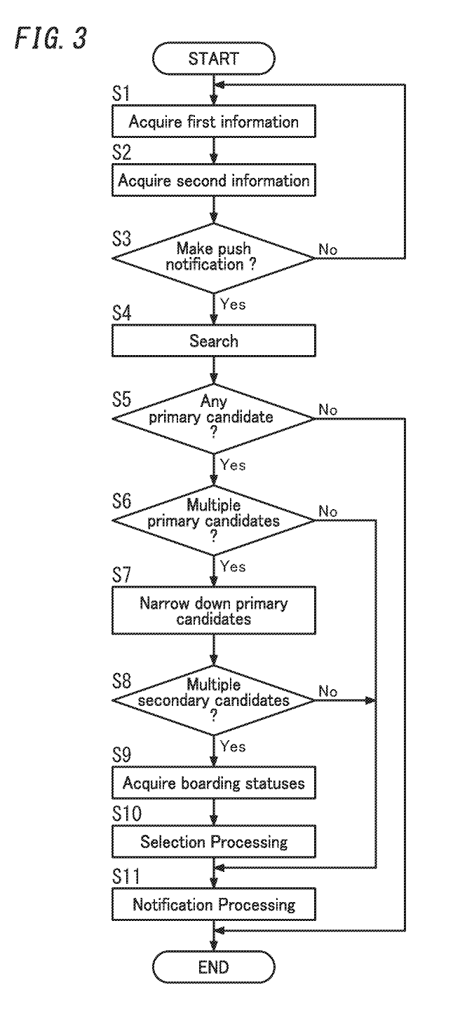

FIG. 3 is a flowchart showing how the boarding management system 1 performs the push notification processing.

The first acquisition unit 201 of the management server 2 communicates, via the communications unit 21, with a plurality of cars 3 (which are objects of management) at regular intervals (of, e.g., a few minutes) to acquire the first set of information from each of the plurality of cars 3 (in Step S1). The first set of information includes pieces of information about the condition of the cars 3. Examples of the first set of information include pieces of information about the current location, speed, traveling direction, destination, scheduled route, number of users, and other parameters of each of those cars 3.

The second acquisition unit 202 of the management server 2 communicates, via the communications unit 21, with the mobile communications device 4 of a potential user 6 who is currently not using any car 3, at regular intervals of e.g., a few minutes, to acquire the second set of information from the mobile communications device 4 of the potential user 6 (in Step S2). The second set of information includes pieces of information about the activity status of the potential user 6. Examples of the second set of information include information about the current location of the potential user 6, condition information about the condition of the potential user 6, and information about the traveling state if the potential user 6 is now traveling.

On acquiring the first and second sets of information, the processing unit 20 decides whether or not to make the push notification (in Step S3). For example, the processing unit 20 may decide whether or not a predetermined starting condition is satisfied to determine that the push notification be or not be made. On finding the predetermined starting condition satisfied, the processing unit 20 determines that the push notification be made (i.e., the answer is YES in Step S3) and performs a series of processing steps S4 and on. On the other hand, on finding the predetermined starting condition not satisfied, the processing unit 20 determines that the push notification not be made (i.e., the answer is NO in Step S3) and the process goes back to the processing step S1.

In this case, the starting condition is defined based on the current location of the potential user 6 (i.e., the mobile communications device 4 carried by the potential user 6). The search unit 203 starts the search processing when a starting condition based on the current location of the potential user 6 is satisfied. For example, the starting condition may be that the current location of the potential user 6 be changing, i.e., that the potential user 6 be moving. The starting condition is defined for each potential user 6, and may be that the potential user 6 now be heading toward a place that the potential user 6 visits at least a predetermined number of times (e.g., at least a few times a week) over a certain period of time. In the example illustrated in FIG. 2, on finding, by reference to the information about the current location of the mobile communications device 4, the potential user 6 heading toward the nearest railway station 200, the processing unit 20 determines that the starting condition be satisfied and that the push notification be made. Alternatively, the starting condition may also be that the potential user 6 have moved from a predetermined location, e.g., that the potential user 6 have left his or her office building 100. As can be seen, the search unit 203 starts the search processing on finding the starting condition based on the current location of the potential user 6 satisfied. This allows the search unit 203 to perform the search processing at an effective timing when the potential user 6 is highly likely to use the moving vehicle 3 and notify the potential user 6 of a recommended candidate.

If the processing unit 20 has determined in Step S3 that the push notification be made, then the search unit 203 performs the processing of searching for a primary candidate car recommended for use to the potential user 6, from among the plurality of cars 3 (in Step S4). The search unit 203 performs the search processing based on the first set of information acquired by the first acquisition unit 201 and the second set of information acquired by the second acquisition unit 202. In this embodiment, the first set of information may include scheduled route information, acquired by the first acquisition unit 201, about scheduled routes of the plurality of cars 3, for example. The second set of information may include location information about the current location of the potential user 6. More specifically, the second set of information may include information about the potential user's 6 predicted activity (e.g., traveling route information about the traveling route of the potential user 6), which has been presumed based on the location information about the current location of the potential user 6 and other pieces of information.

As can be seen, the search unit 203 of this embodiment performs, based on the cars' 3 scheduled route information acquired by the first acquisition unit 201 and the potential user's 6 predicted activity information acquired by the second acquisition unit 202, the search processing of searching for a recommended candidate from among the plurality of cars 3. As used herein, the “predicted activity information” may be information about a traveling route R10 that the potential user 6 follows to travel from the current location to the destination (e.g., the station 200 in the example illustrated in FIG. 2). The search unit 203 searches for, as a primary candidate, a car 3, of which the scheduled route is proximate to the potential user's 6 traveling route R10 and which is scheduled to travel toward the potential user's 6 destination (e.g., the station 200 in the example illustrated in FIG. 2). As used herein, the situation where the “traveling route R10 is proximate to the scheduled route” refers to both a situation where the car 3 passes through a part of the traveling route R10 and a situation where the car 3 passes through a road located within a certain distance from the traveling route R10. In the latter case, scheduled routes R1, R2 of the car 3 may be changed such that the car 3 passes through the boarding location where the potential user 6 is expected to board the car 3. However, changing the scheduled routes R1, R2 may prolong the amount of time it takes for the passenger already riding the car 3 (hereinafter referred to as an “on-board passenger”) to arrive at the destination. That is why the search unit 203 suitably searches for a primary candidate car such that the change of the traveling routes R10 will cause an arrival delay falling within a predetermined allowable range (of, e.g., five minutes). In other words, the search unit 203 searches for a recommended candidate from among the plurality of cars 3 by taking, into account, how the on-board passenger's terms of use will be affected when each of the plurality of cars 3 is used by the potential user. This allows the search unit 203 to search for a recommended candidate from among the plurality of cars 3, depending on the degree of change of the terms of use of the on-board passenger.

If the search unit 203 has found no primary candidate cars as a result of the search processing (if the answer is NO in Step S5), then the processing unit 20 does not make any push notification to end the process.

On the other hand, if the search unit 203 has found one or more primary candidate cars as a result of the search processing (if the answer is YES in Step S5), then the search unit 203 determines whether or not there are a plurality of primary candidate cars (in Step S6).

If there is only one primary candidate car (if the answer is NO in Step S6), then the search unit 203 regards the only one primary candidate car detected as a recommended candidate and the notification unit 204 performs notification processing (in Step S11). The notification processing performed by the notification unit 204 will be described later.

On the other hand, if there are a plurality of primary candidate cars (if the answer is YES in Step S6), then the search unit 203 narrows down the search for a primary candidate car (in Step S7). For example, if two cars 3 have been found as primary candidate cars as in the example illustrated in FIG. 2, then the search unit 203 performs the processing of narrowing down the two cars 3 to one recommended candidate car 3. In this example, when the two cars 3 found as primary candidate cars need to be distinguished from each other, these two cars 3 will be designated herein by the reference signs 3A and 3B, respectively. The search unit 203 calculates the narrowest gaps between the cars 3A, 3B and the potential user 6 based on the scheduled routes R1 and R2 obtained in accordance with the driving instruction information for the cars 3A and 3B and the potential user's 6 locations presumed on the basis of a predetermined time unit by reference to the second set of information (including current location, traveling speed, and traveling direction). The search unit 203 narrows down the primary candidate cars to one recommended candidate car by choosing a car 3, of which the narrowest gap with respect to the potential user 6 is equal to or less than a first predetermined decision gap, from the two candidate cars 3A and 3B. The search unit 203 also narrows down the primary candidate cars based on the distances from the potential user's 6 current location to the most proximate locations (e.g., the locations P11 and P12 shown in FIG. 2) where the cars 3 are located most proximate to the potential user 6. That is to say, the search unit 203 narrows down the primary candidate cars to one recommended candidate car by choosing a car 3, of which the distance from the potential user's 6 current location to the most proximate location is equal to or less than a second predetermined decision distance, from the two candidate cars 3A and 3B. In the example illustrated in FIG. 2, the narrowest gaps between the cars 3A, 3B and the potential user 6 at the most proximate locations are both equal to or less than the first decision gap. However, the distance from the potential user's 6 current location to the most proximate location of the car 3A is equal to or less than the second decision distance, whereas the distance from the potential user's 6 current location to the most proximate location of the car 3B is longer than the second decision distance. Thus, the search unit 203 regards the car 3A as a secondary candidate car.

If the primary candidate cars have been narrowed down through the narrowing processing step S7 to one secondary candidate car (if the answer is NO in Step S8), then the search unit 203 regards the secondary candidate car (e.g., the car 3A in the example illustrated in FIG. 2) as a recommended candidate and the notification unit 204 performs the notification processing (in Step S11). It will be described later how the notification unit 204 performs the notification processing.

On the other hand, if the primary candidate cars have been narrowed down through the narrowing processing step S7 to plurality of secondary candidate cars (if the answer is YES in Step S8), then the search unit 203 performs the processing of choosing a recommended candidate from the plurality of secondary candidates. For example, the search unit 203 may determine the recommended candidate based on the respective numbers of passengers using the plurality of secondary candidate cars and the respective numbers of vacant seats thereof.

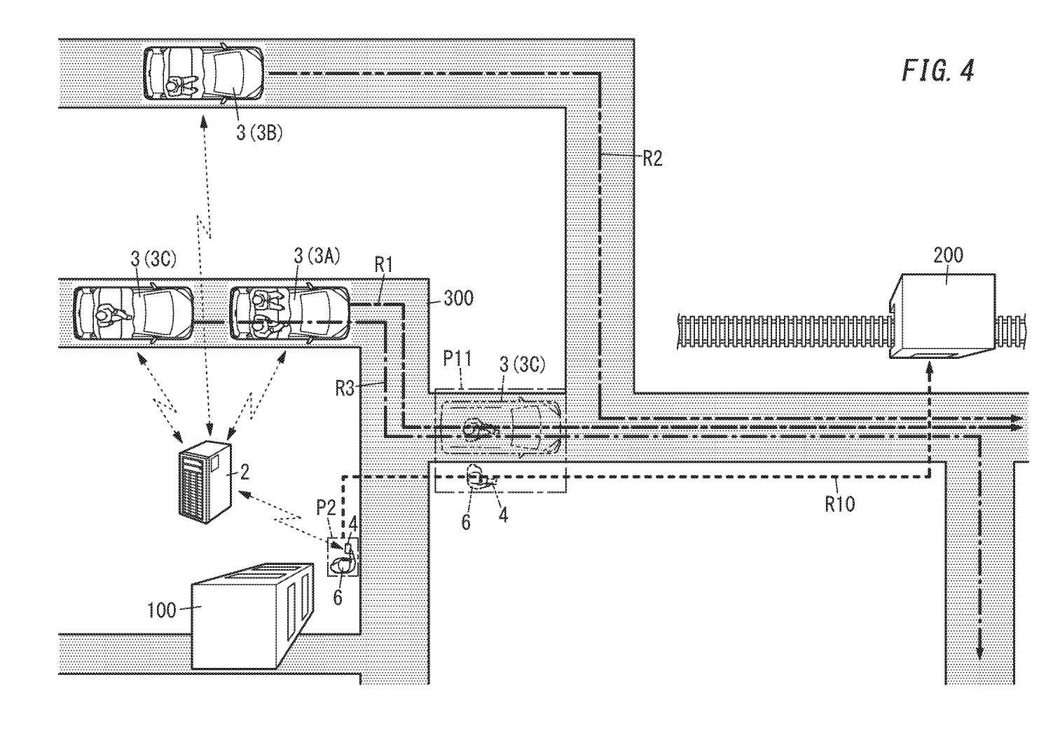

In the following example, it will be described how the search unit 203 determines the recommended candidate in a situation where two cars 3A and 3C with the same scheduled route R1 and R3 to the station 200 have been found as secondary candidate cars as a result of the search as shown in FIG. 4.

The search unit 203 acquires, based on the first set of information acquired by the first acquisition unit 201 from the cars 3A and 3C, boarding information about boarding states of the cars 3A and 3C (in Step S9). As used herein, the boarding information includes number of passengers information about the respective numbers of passengers using the cars 3A and 3C and seat availability information about the respective numbers of vacant seats of the cars 3A and 3C. Then, the search unit 203 chooses, by reference to the boarding information of the cars 3A and 3C, either the car 3A or the car 3C that has the smaller number of passengers as a recommended candidate (in Step S10). That is to say, the search unit 203 searches for the recommended candidate based on the second set of information including the number of passengers information about the respective numbers of passengers using the plurality of moving vehicles 3. For instance, in the example illustrated in FIG. 4, the number of passengers using the car 3A is two and the number of passengers using the car 3C is one. Thus, the search unit 203 chooses the car 3C with the smaller number of passengers as a recommended candidate. A car with the smaller number of passengers would have the smaller number of stops (or deboarding locations) and would take the shorter amount of time to arrive at the destination. Therefore, such a secondary candidate car that would arrive at the destination sooner may be chosen as the recommended candidate. Alternatively, the search unit 203 may also choose, by reference to the boarding information of the cars 3A and 3C, one of these two cars 3A, 3C that has the larger number of vacant seats. In that case, the search unit 203 chooses a secondary candidate car with the larger number of vacant seats as the recommended candidate, thus choosing a recommended candidate allowing the user to be seated more comfortably. Optionally, the search unit 203 may also determine the recommended candidate based on the respective numbers of passengers and the respective numbers of vacant seats of the plurality of secondary candidate cars. For example, the search unit 203 may choose secondary candidate car(s) with the smallest number of passengers from a plurality of secondary candidate cars. If there are two or more secondary candidate cars with the smallest number of passengers, then the search unit 203 chooses one secondary candidate car with the largest number of vacant seats.

Still alternatively, the search unit 203 may also search for a recommended candidate from among a plurality of moving vehicles 3 based on an estimated amount of time it takes for the potential user 6 to arrive at his or her destination. For example, in determining a recommended candidate from among a plurality of secondary candidate cars, the search unit 203 may estimate the respective amounts of time it would take for the plurality of secondary candidate cars to arrive at the destination. In this case, the amount of time is the sum of the amount of time it takes for the potential user 6 to travel from the current location to the boarding location, the amount of time he or she has to wait at the boarding location until he or she boards the car 3, and the amount of time it takes for the car 3 to arrive at the destination from the boarding location. The search unit 203 determines the recommended candidate based on the amount of time it takes for the potential user 6 to arrive at the destination, thus choosing the best recommended candidate. Optionally, the search unit 203 may also determine the recommended candidate based on the amount of time it takes for the potential user 6 to arrive at his or her destination and any other appropriate condition (such as the distance to the boarding location or the fare) in combination.

Alternatively, in the embodiment described above, the second acquisition unit 202 may acquire, as another piece of the second set of information, destination information about the potential user's 6 destination and the search unit 203 may search for a recommended candidate based on the destination information about the potential user's 6 destination. In that case, the second acquisition unit 202 may acquire, from a mobile communications device 4, the destination information about the destination entered by the potential user 6 into the mobile communications device 4. The second acquisition unit 202 may acquire the destination information by presuming the potential user's 6 destination based on the current location and traveling direction, acquired from the mobile communications device 4, of the mobile communications device 4 and information about the past history. In any case, the search unit 203 may search for a car 3 traveling toward the potential user's 6 destination based on the destination information about the potential user's 6 destination.

Once the recommended candidate has been determined as described above, the notification unit 204 performs the notification processing of notifying the potential user 6 of the recommended candidate (in Step S11). The notification processing will be described in detail below. The notification unit 204 composes a notification message recommending the use of the recommended candidate and sends the notification message to the potential user's 6 mobile communications device 4 via the communications unit 21. The notification message contains pieces of information about the boarding location where the potential user is expected to board the recommended candidate car 3 (e.g., the location P11 shown in FIGS. 2 and 4), the scheduled boarding time, the estimated time of arrival at the destination (e.g., the station 200), and the fare. In this case, the fare may be set based on the distance from the boarding location P11 to the destination, a time of the day of boarding the car 3, the number of passengers sharing the car 3, and other factors. Optionally, the notification message may also contain other pieces of information about the type or model of the recommended candidate car 3, an attribute of the car 3 (e.g., whether it is a non-smoking car or not), the number of passengers sharing the car 3, and other pieces of information.

When the communications unit 41 of the mobile communications device 4 carried by the potential user 6 receives the notification message from the management server 2, the processing unit 40 may have the notification message, recommending the use of the recommended candidate, displayed on the display unit 43. Alternatively, the processing unit 40 may also have the message, recommending the use of the recommended candidate, emitted as a voice message from a loudspeaker, for example.

The potential user 6, who has received or listened to this message, may decide to use the recommended candidate car 3. In that case, he or she performs the operation of making a boarding reservation for the recommended candidate car 3 using the operating unit 44. In that case, the processing unit 40 of the mobile communications device 4 has reservation request information, entered by operating the operating unit 44, transmitted from the communications unit 41 to the management server 2 over the communications network 5. On receiving this reservation request information from the mobile communications device 4 via the communications unit 21 after having had the notification message, recommending the use of the recommended candidate, transmitted to the mobile communications device 4 via the communications unit 21, the processing unit 20 of the management server 2 accepts the boarding reservation for the recommended candidate car 3. The potential user 6 who has made a boarding reservation for the car 3 will be hereinafter referred to as a “scheduled passenger.” That is to say, the user is a potential user 6 before deciding to use the car 3 and becomes a scheduled passenger 6 once he or she made a boarding reservation for the car 3.

The dispatch processing unit 206 of the management server 2 generates driving instruction information to carry the scheduled passenger 6 from the boarding location P11 to his or her destination (i.e., the station 200 in this example) and has the driving instruction information transmitted to the recommended candidate car 3 via the communications unit 21. In this case, the driving instruction information may contain pieces of information about the boarding location P11 and scheduled boarding time of the scheduled passenger 6 and the deboarding location (e.g., the station 200 in this example) where the scheduled passenger 6 is going to get out of the car 3 and the scheduled deboarding time (i.e., the estimated time of arrival at the station 200). The processing unit 30 of the recommended candidate car 3 controls the driving control unit 34 in accordance with the driving instruction information received from the management server 2 to drive the car 3 to the boarding location P11. On picking up the scheduled passenger 6 carrying the mobile communications device 4 by stopping at the boarding location P11, the processing unit 30 of the car 3 drives the car 3 toward the next destination (which may be the deboarding location of the passenger 6 who has just gone aboard, the deboarding location of the on-board passenger who has already been aboard the car 3, or the boarding location of another user (i.e., another scheduled passenger)). Thereafter, when the car 3 arrives at the deboarding location (e.g., the station 200) of the passenger 6, the processing unit 30 of the car 3 stops the car 3 at the deboarding location to allow the passenger 6 to get out of the car 3, and then resumes driving the car 3 toward the next destination.

This allows the potential user 6 who originally had no intention of using the ride sharing services to use the car 3 that provides the ride sharing services, and also saves him or her the trouble to look for, by him- or herself, such a car 3 that provides the ride sharing service. This provides a user-friendly boarding management system 1 with improved convenience for users. In addition, this also allows the administrator of the boarding management system 1 to recommend the potential user 6, who originally has no intention of using the ride sharing services, to use the car 3, thus improving efficiency of transportation and increasing the utilization rate of the car 3 at a time. Furthermore, this also reduces the fare to be paid by the user who has already been aboard the car 3, because the number of the passengers sharing the car 3 has been increased by one by making the potential user 6 board the car 3.

Note that the recommended candidate car 3 may be configured to obtain agreement to have the potential user 6 on board from the on-board passenger who has already been aboard the car 3. For that purpose, the processing unit 30 may have a question, asking the on-board passenger if he or she agrees on having the potential user 6 on board with him or her, displayed on a display device such as a liquid crystal display installed inside the car 3. When receiving an affirmative reply or no negative reply to this question, the processing unit 30 transmits a response, indicating that the on-board passenger agrees to have the potential user 6 on board, to the management server 2 and allows the potential user 6 to share the car 3 with the on-board passenger.

Also, if the potential user 6, who has received the notification in Step S11, declines to use the recommended candidate car 3, there is no need for the potential user 6 to make any operations at this time. The processing unit 20 of the management server 2 makes the communications unit 21 send a notification message recommending the use of the recommended candidate to the mobile communications device 4. If the processing unit 20 receives no reservation request information from the mobile communications device 4 within a predetermined amount of time, then the processing unit 20 determines that the potential user 6 have no intention of using the recommended candidate, and ends the process.

(2.2.2) Reservation Cancellation Processing

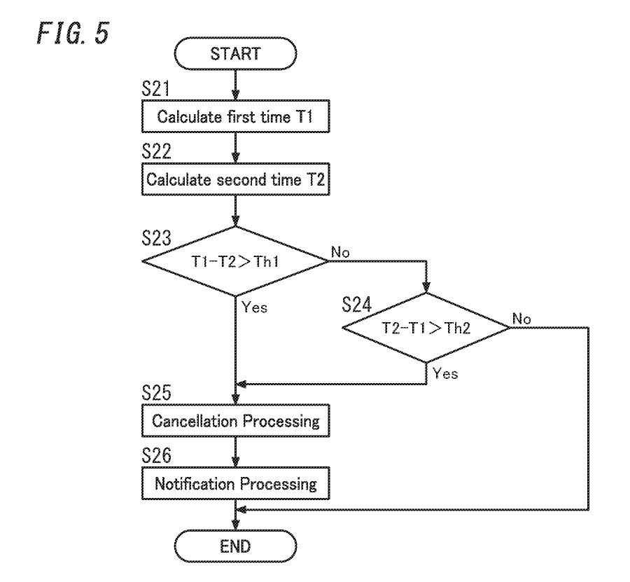

Next, it will be described with reference to FIGS. 4-7 how the boarding management system 1 performs the reservation cancellation processing of canceling, after having once accepted a boarding reservation for the car 3A from a user (i.e., a scheduled passenger 6), his or her boarding reservation. Note that the boarding reservation received from the user includes two types of boarding reservations, namely, a boarding reservation made by the user him- or herself and a boarding reservation made by the potential user 6 in response to the push notification.

Once the processing unit 20 of the management server 2 has received a boarding reservation from the scheduled passenger 6, the time prediction unit 205 performs the processing of calculating a first time T1 (in Step S21) and the processing of calculating a second time T2 (in Step S22) at regular time intervals (e.g., on the order of one minute to several minutes). The first time T1 is a time when the car 3A that the scheduled passenger 6 is scheduled to board is expected to arrive at the boarding location P11. The second time T2 is a time when the scheduled passenger 6 is going to arrive at the boarding location P11.

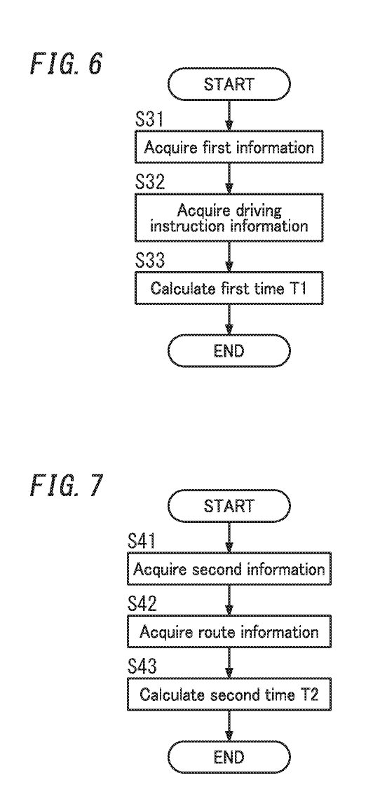

First, it will be described with reference to FIG. 6 how the time prediction unit 205 performs the processing of calculating the first time T1. The first acquisition unit 201 of the management server 2 acquires, via the communications unit 21, the first set of information about the condition of the car 3A that the scheduled passenger 6 is scheduled to board from the car 3A at regular time intervals (in Step S31). The first set of information includes at least the location information about the current location P1 (see FIG. 4) of the car 3A and speed information thereof. The time prediction unit 205 acquires driving instruction information about the car 3A that the scheduled passenger 6 is scheduled to board from the storage unit 22 (in Step S32). The driving instruction information includes information about the scheduled route of the car 3A. The time prediction unit 205 obtains the traveling distance to the boarding location P11 based on information about the scheduled route of the car 3A and the location information about the current location P1 of the car 3A. In addition, the time prediction unit 205 also calculates, based on this traveling distance and the information about the speed of the car 3A, the first time T1 when the car 3A is expected to arrive at the boarding location P11 (in Step S33). Optionally, the time prediction unit 205 may calculate the first time T1 with pieces of traffic information, acquired by the management server 2 from a vehicle information and communication system (VICS), for example, about traffic accidents, road work, and traffic jams, also taken into account.

Next, it will be described with reference to FIG. 7 how the time prediction unit 205 performs the processing of calculating the second time T2. The second acquisition unit 202 of the management server 2 acquires, via the communications unit 21, the second set of information about the activity status of the scheduled passenger 6, at regular time intervals, from the mobile communications device 4 carried by the scheduled passenger 6 (in Step S41). The second set of information includes at least information about the current location P2 (see FIG. 4) of the scheduled passenger 6. In this embodiment, the second set of information includes information about the traveling speed of the scheduled passenger 6. The time prediction unit 205 obtains, by reference to map information loaded from the storage unit 22, route information indicating the scheduled passenger's 6 traveling route from the current location P2 to the boarding location P11 (in Step S42). Next, the time prediction unit 205 obtains the traveling distance based on the traveling route information of the scheduled passenger 6 and then calculates, based on the traveling distance and traveling speed of the scheduled passenger 6, the second time T2 when the scheduled passenger 6 is going to arrive at the boarding location P11 (in Step S43).

When the time prediction unit 205 has calculated the first time T1 and the second time T2, the cancellation decision unit 207 decides, depending on the time lag between the first time T1 and the second time T2, whether or not to perform cancellation processing of canceling the boarding reservation made by the scheduled passenger 6 (in Step S23 and S24).

First of all, the cancellation decision unit 207 compares the time lag (T1-T2), obtained by subtracting the second time T2 from the first time T1, to a first threshold value Th1 (in Step S23). The time lag (T1-T2), obtained by subtracting the second time T2 from the first time T1, has a positive value in a situation where the scheduled passenger 6 arrives at the boarding location P11 earlier than the car 3A. In that case, the time lag (T1-T2), obtained by subtracting the second time T2 from the first time T1, corresponds to the scheduled passenger's 6 waiting time.

When finding the time lag (T1-T2), obtained by subtracting the second time T2 from the first time T1, greater than the first threshold value Th1 (i.e., when finding the scheduled passenger's 6 waiting time greater than the first threshold value Th1) (if the answer is YES in Step S23), the cancellation decision unit 207 proceeds to Step S25 to perform the processing of canceling the boarding reservation.

On the other hand, when finding the time lag (T1-T2), obtained by subtracting the second time T2 from the first time T1, equal to or less than the first threshold value Th1 (i.e., when finding the scheduled passenger's 6 waiting time equal to or less than the first threshold value Th1) (if the answer is NO in Step S23), the cancellation decision unit 207 proceeds to the decision processing step S24.

In Step S24, the cancellation decision unit 207 compares the time lag (T2-T1), obtained by subtracting the first time T1 from the second time T2, to a second threshold value Th2. The time lag (T2-T1), obtained by subtracting the first time T1 from the second time T2, has a positive value in a situation where the car 3A arrives at the boarding location P11 earlier than the scheduled passenger 6. In that case, the time lag (T2-T1), obtained by subtracting the first time T1 from the second time T2 corresponds to the car's 3A waiting time.

When finding the time lag (T2-T1), obtained by subtracting the first time T1 from the second time T2, equal to or less than the second threshold value Th2 (i.e., when finding the car's 3A waiting time equal to or less than the second threshold value Th2) (if the answer is NO in Step S24), the cancellation decision unit 207 ends the process without performing the processing of canceling the boarding reservation.

On the other hand, when finding the time lag (T2-T1), obtained by subtracting the first time T1 from the second time T2, greater than the second threshold value Th2 (i.e., when finding the car's 3A waiting time greater than the second threshold value Th2) (if the answer is YES in Step S24), the cancellation decision unit 207 proceeds to Step S25 to perform the processing of canceling the boarding reservation.

In this case, the first and second threshold values Th1 and Th2 for the waiting times may be set by the setting unit 208. Since the car 3A is shared by a plurality of users, the setting unit 208 sets the second threshold value Th2 at a value smaller than the first threshold value Th1 to shorten the waiting time of the on-board passengers that are aboard the car 3A. In one example, the first threshold value Th1 corresponding to the scheduled passenger's 6 waiting time may be 30 minutes and the second threshold value Th2 corresponding to the car's 3A waiting time may be 10 minutes, for example.

When finding the time lag (T1-T2) greater than the first threshold value Th1 (if the answer is YES in Step S23) or finding the time lag (T2-T1) greater than the second threshold value Th2 (if the answer is YES in Step S24), the cancellation decision unit 207 decides to perform the processing of canceling the boarding reservation made by the scheduled passenger 6 (in Step S25). When the cancellation decision unit 207 decides to perform the processing of canceling the boarding reservation, the dispatch processing unit 206 generates driving instruction information indicating an updated scheduled route of the car 3A, from which schedules for boarding and deboarding the scheduled passenger 6 have been removed.

Then, the notification unit 204 of the management server 2 has cancellation notification information, indicating that the boarding reservation has been canceled, transmitted from the communications unit 21 to the mobile communications device 4 carried by the scheduled passenger 6, and also has the updated driving instruction information transmitted from the communications unit 21 to the car 3A (in Step S26).

When the communications unit 41 of the mobile communications device 4 carried by the scheduled passenger 6 receives the cancellation notification information from the management server 2, the processing unit 40 of the mobile communications device 4 has a notification message, indicating that the boarding reservation has been canceled in accordance with the cancellation notification information, displayed on the display unit 43. This message allows the scheduled passenger 6 to learn that his or her boarding reservation for the car 3A has been canceled. Meanwhile, when the communications unit 31 of the car 3A receives the driving instruction information from the management server 2, the processing unit 30 controls the driving control unit 34 to drive the car 3A following the updated scheduled route.

As can be seen, if the arrival of either the scheduled passenger 6 or the car 3A at the boarding location P11 is delayed, then the management server 2 automatically cancels the boarding reservation made by the scheduled passenger 6. This saves the scheduled passenger 6 the trouble to cancel the boarding reservation by him- or herself and provides a boarding management system 1 with improved user friendliness. In addition, if it is predicted that the arrival of either the scheduled passenger 6 or the car 3A would be delayed, the management server 2 cancels, in advance, the boarding reservation made by the scheduled passenger 6. This avoids a situation where the scheduled passenger 6 or the on-board passenger already aboard the car 3A has to wait at the boarding location P11 for an amount of time longer than the threshold value. This provides a boarding management system 1 with further improved user-friendliness and convenience.

Optionally, when canceling the boarding reservation, the notification unit 204 of the management server 2 may transmit the cancellation notification information with a reason for canceling the boarding reservation (such as the delay of either the car 3A or the scheduled passenger 6) to the mobile communications device 4. The processing unit 40 of the mobile communications device 4 displaying the reason for cancellation, included in the cancellation notification information, on the display unit 43 tells the scheduled passenger 6 why his or her boarding reservation has been canceled.

In the boarding management system 1 of this embodiment, when the cancellation decision unit 207 decides to perform the cancellation processing, the boarding location proposal unit 209 may perform proposal processing of proposing changing the boarding locations to the scheduled passenger 6.

The boarding location proposal unit 209 selects an alternative boarding location based on information, acquired by the first acquisition unit 201, about the current location P1 of the car 3A and information, acquired by the second acquisition unit 202, about the current location P2 of the scheduled passenger 6 (hereinafter referred to as “current location information”). For example, if it is predicted that the arrival of the scheduled passenger 6 would be delayed, then changing the boarding locations of the scheduled passenger 6 to a new location closer to the current location P2 of the scheduled passenger 6 than the previous boarding location P11 allows the second time T2 when the scheduled passenger 6 is going to arrive at the new boarding location to be earlier than the second time T2 when he or she would otherwise arrive at the previous boarding location P11. The boarding location proposal unit 209 selects the alternative boarding location such that the time lag (T2-T1) between the first time T1 and the second time T2 becomes equal to or less than the second threshold value Th2. Then, the boarding location proposal unit 209 makes the notification unit 204 transmit proposal information, proposing an alternative boarding location, to the mobile communications device 4 of the scheduled passenger 6 via the communications unit 21. In this case, in the mobile communications device 4 carried by the scheduled passenger 6, the communications unit 41 receives the information about the alternative boarding location from the management server 2 and the processing unit 40 has the information about the alternative boarding location displayed on the display unit 43. When the scheduled passenger 6 performs the operation of approving of the change of the boarding locations by using the operating unit 44, the processing unit 40 has a response signal, indicating that the change of the boarding locations has been approved of, transmitted to the management server 2 via the communications unit 41. On receiving, via the communications unit 21, the response signal indicating that the change of the boarding locations has been approved of from the mobile communications device 4 of the scheduled passenger 6, the processing unit 20 of the management server 2 makes the dispatch processing unit 206 generate driving instruction information indicating that the boarding locations be changed, and has the driving instruction information transmitted from the communications unit 21 to the car 3A. As can be seen, when finding the waiting time at the boarding location greater than the threshold value, the boarding management system 1 changes the boarding locations for the scheduled passenger 6, thus shortening the waiting time at the boarding location and improving the efficiency of transportation.

In this case, changing the boarding locations could make the scheduled route of the car 3A longer than the previously selected route. Thus, the management server 2 may transmit, to the car 3A, notification information asking the scheduled passenger 6 if he or she approves of the change of the scheduled routes. When the communications unit 31 of the car 3A receives the notification information from the management server 2, the processing unit 30 may have a question, asking the on-board passenger if he or she approves of a change the scheduled routes, displayed on a display device such as a liquid crystal display installed inside the car 3A. When receiving an affirmative reply or no negative reply to this question from the on-board passenger who is already aboard the car 3A, the processing unit 30 transmits a response, indicating that the on-board passenger has approved of the change of the scheduled routes, to the management server 2 and allows the scheduled passenger 6 to board the car 3A at the new boarding location.

In addition, in the boarding management system 1 of this embodiment, when the cancellation decision unit 207 decides to perform the cancellation processing, the alternative vehicle proposal unit 210 may perform proposal processing of proposing boarding an alternative car 3 (i.e., a second moving vehicle) to the scheduled passenger 6.

For instance, it will be described what if the scheduled passenger 6 has made a boarding reservation for the car 3A in the example illustrated in FIG. 4. In the following description, the moving vehicle 3A, for which the scheduled passenger 6 has made a boarding reservation, will be hereinafter referred to as a “first moving vehicle.”

If the cancellation decision unit 207 has found the car's 3A waiting time at the boarding location greater than the second threshold value Th2 and decided to perform the processing of canceling the boarding reservation, then the alternative vehicle proposal unit 210 makes the search unit 203 search for an alternative car 3. The search unit 203 searches, based on the first set of information acquired by the first acquisition unit 201 and the second set of information acquired by the second acquisition unit 202, for a car 3C as an alternative car (second moving vehicle) from among a plurality of cars 3 other than the car 3A. The search unit 203 also selects a new boarding location where the scheduled passenger 6 is expected to board the alternative car 3C. When the search unit 203 finds the alternative car 3C and determines the new boarding location for the car 3C, the alternative vehicle proposal unit 210 has notification information about the alternative car 3C and the new boarding location transmitted from the notification unit 204 to the mobile communications device 4 of the scheduled passenger 6 via the communications unit 21.

At this time, in the mobile communications device 4 carried by the scheduled passenger 6, the communications unit 41 receives the notification information from the management server 2 and the processing unit 40 has information about the alternative car 3C and the new boarding location displayed on the display unit 43. When the scheduled passenger 6 performs the operation of making a reservation for the alternative car 3C by using the operating unit 44, the processing unit 40 has reservation request information transmitted to the management server 2 via the communications unit 41. On receiving the reservation request information from the mobile communications device 4 of the scheduled passenger 6 via the communications unit 21, the processing unit 20 of the management server 2 makes the dispatch processing unit 206 generate driving instruction information indicating that the scheduled routes of the car 3C be changed and has the driving instruction information transmitted from the communications unit 21 to the car 3. As can be seen, on finding the waiting time at the boarding location greater than the threshold value, the boarding management system 1 proposes the alternative car 3C and the new boarding location to the scheduled passenger 6, thus improving the efficiency of transportation.

In this case, the scheduled route of the alternative car 3C could be longer than the previously selected route. Thus, the management server 2 may transmit, to the car 3C, notification information asking the scheduled passenger 6 if he or she approves of the change of the scheduled routes. When the communications unit 31 of the car 3C receives the notification information from the management server 2, the processing unit 30 may have a question, asking the on-board passenger if he or she approves of the change of the scheduled routes, displayed on a display device such as a liquid crystal display installed inside the car 3C. When receiving an affirmative reply or no negative reply to this question from the on-board passenger who is already aboard the car 3C, the processing unit 30 transmits a response, indicating that the on-board passenger approves of the change of the scheduled routes, to the management server 2 and allows the scheduled passenger 6 to board the car 3A at the boarding location indicated by the driving instruction information.

Note that if the alternative vehicle proposal unit 210 has made the search unit 203 search for an alternative car 3 only to find no alternatives, then the alternative vehicle proposal unit 210 may transmit, via the communications unit 21, a notification signal indicating that no alternative cars 3 have been found to the mobile communications device 4 of the scheduled passenger 6. This notification signal received at the mobile communications device 4 tells the scheduled passenger 6 that no alternative cars 3 have been found.

### (3) Variations

The embodiment described above is only one of various embodiments of the present disclosure, and may be readily modified, changed, replaced, or combined with any other embodiments, depending on a design choice or any other factor, without departing from a true spirit and scope of the present disclosure. Also, the same function as that of the boarding management system 1 may be implemented as a boarding management method, a computer program, or a non-transitory storage medium that stores the program thereon, for example. A boarding management method according to an aspect includes deciding, depending on a time lag between a first time T1 and a second time T2, whether or not to perform cancellation processing of canceling a boarding reservation, made by a scheduled passenger 6, for a moving vehicle 3. The first time T1 is a time when the moving vehicle 3 is expected to arrive at a boarding location. The second time T2 is a time when the scheduled passenger 6 is going to arrive at the boarding location.

A (computer) program according to another aspect is designed to make a computer system perform cancellation decision processing. The cancellation decision processing includes deciding, depending on a time lag between a first time T1 and a second time T2, whether or not to perform cancellation processing of canceling a boarding reservation, made by a scheduled passenger 6, for a moving vehicle 3. The first time T1 is a time when the moving vehicle 3 is expected to arrive at a boarding location. The second time T2 is a time when the scheduled passenger 6 is going to arrive at the boarding location.

Next, variations of the embodiment will be enumerated one after another. Optionally, any of the variations to be described below may be adopted in combination as appropriate.

The boarding management system 1 and the agent that carries out the boarding management method according to the present disclosure each includes a computer system. The computer system includes, as principal hardware components, a processor and a memory. The functions of the boarding management system 1 or the agent that carries out the boarding management method according to the present disclosure is performed by making the processor execute the program stored in the memory of the computer system. The program may be stored in advance in the memory of the computer system. Alternatively, the program may also be downloaded through a telecommunications line or be distributed after having been stored in some computer-readable non-transitory storage medium. Examples of the computer-readable non-transitory storage media include a memory card, an optical disc, and a hard disk drive. The processor of the computer system is made up of a single or a plurality of electronic circuits including a semiconductor integrated circuit (IC) or a largescale integrated circuit (LSI). Those electronic circuits may be integrated together on a single chip or distributed on multiple chips without limitation. Those multiple chips may be integrated together in a single device or distributed in multiple devices without limitation.

Also, in the embodiment described above, the boarding management system 1 is implemented as a single management server 2. However, this is only an example and should not be construed as limiting. Alternatively, the cancellation decision unit 207, time prediction unit 205, setting unit 208, boarding location proposal unit 209, and alternative vehicle proposal unit 210 of the boarding management system 1 may also be implemented as two or more distributed systems. In an alternative embodiment, the function of each of the cancellation decision unit 207, time prediction unit 205, setting unit 208, boarding location proposal unit 209, and alternative vehicle proposal unit 210 may be distributed in a plurality of systems. Optionally, at least some function of the boarding management system 1 may be implemented as a cloud computing system as well.

In the embodiment described above, the cancellation decision unit 207 decides, depending on the time lag between the first time and the second time, whether or not to perform the cancellation processing. Thus, if the arrivals of the scheduled passenger 6 and the car 3 are both delayed to approximately the same degree to make the time lag between the first time and the second time equal to or less than the threshold value, then the cancellation decision unit 207 will not cancel the boarding reservation. In that case, the scheduled passenger 6 will get in and out of the originally reserved car 3, thus possibly causing a more significant delay of the car 3. Thus, to avoid such a situation, the cancellation decision unit 207 may decide, with a scheduled boarding time when the scheduled passenger 6 is scheduled to board the car 3 further taken into account, whether or not to perform the cancellation processing. For example, when predicting that the time lag between the first time when the car 3 is expected to arrive at the boarding location and the scheduled boarding time would be greater than a third threshold value, the cancellation decision unit 207 may decide to perform the processing of canceling the boarding reservation. This shortens the delay of the car 3. Likewise, when predicting that the time lag between the second time when the scheduled passenger 6 is going to arrive at the boarding location and the scheduled boarding time would be greater than the third threshold value, the cancellation decision unit 207 may decide to perform the processing of canceling the boarding reservation. This shortens the delay of the car 3 as well.

Furthermore, in the boarding management system 1 of the embodiment described above, when the cancellation decision unit 207 performs the processing of canceling the boarding reservation, the cancellation processing may be performed differently depending on which of the car 3 or the scheduled passenger 6 arrives at the boarding location earlier.

For example, if the car 3 arrives at the boarding location earlier than the scheduled passenger 6, then the car 3 will make the other on-board passenger(s) wait until the scheduled passenger 6 arrives there. Thus, in such a situation, the cancellation decision unit 207 performs the cancellation processing of canceling his or her boarding reservation, regardless of his or her intention.

On the other hand, if the scheduled passenger 6 arrives at the boarding location earlier than the car 3 but finds the waiting time acceptable, then the boarding reservation does not always have to be canceled. Thus, the cancellation decision unit 207 has notification information, asking the scheduled passenger 6 if he or she agrees to cancel the boarding reservation, transmitted to the mobile communications device 4 via the communications unit 21. When the communications unit 41 of the mobile communications device 4 receives the notification information from the management server 2, the processing unit 40 may have a question, asking the scheduled passenger 6 if he or she agrees to cancel the boarding reservation, displayed on a display device 43. In this case, if the scheduled passenger 6 performs the operation of canceling the boarding reservation using the operating unit 44 of the mobile communications device 4, then the processing unit 40 has an operating signal, instructing that the boarding reservation be canceled, transmitted to the management server 2 via the communications unit 41. In response, the processing unit 20 of the management server 2 performs the processing of canceling the boarding reservation. On the other hand, if the scheduled passenger 6 performs the operation of keeping his or her boarding reservation using the operating unit 44 of the mobile communications device 4, then the processing unit 40 has an operating signal, instructing that the boarding reservation be kept, transmitted to the management server 2 via the communications unit 41. Thus, the processing unit 20 of the management server 2 does not perform the processing of canceling the boarding reservation. This allows the management server 2 to decide, depending on the answer to the question for the scheduled passenger 6, whether or not to cancel the boarding reservation.

This allows the boarding management system 1 to perform the cancellation processing differently depending on which of the car 3 or the scheduled passenger 6 arrives at the boarding location earlier.

Optionally, in the boarding management system 1 of the embodiment described above, the cancellation decision unit 207 may also decide, with another predetermined decision condition other than the time lag taken into account, whether or not to perform the cancellation processing.

As used herein, the “predetermined decision condition” may be a decision condition based on the activity prediction of the scheduled passenger 6, for example. Specifically, when finding the result of the activity prediction of the scheduled passenger 6 not meeting the decision condition that he or she be heading toward the boarding location, the cancellation decision unit 207 performs the cancellation processing of canceling the boarding reservation made by the scheduled passenger 6. The second acquisition unit 202 predicts the activity of the scheduled passenger 6 based on the location information acquired from the mobile communications device 4 of the scheduled passenger 6. The cancellation decision unit 207 performs the cancellation processing with the result of the activity prediction by the second acquisition unit 202 taken into account. For example, if the second acquisition unit 202 has obtained a prediction result that the scheduled passenger 6 has been staying in the same place (such as a store or a restaurant), then the cancellation decision unit 207 determines that the scheduled passenger 6 not be heading toward the boarding location and decides to perform the cancellation processing. Also, if the second acquisition unit 202 has obtained a prediction result that the scheduled passenger 6 be traveling in the opposite direction from the boarding location or be heading toward a different destination, then the cancellation decision unit 207 may determine that the scheduled passenger 6 not be heading toward the boarding location. As can be seen, the cancellation decision unit 207 decides, with another predetermined decision condition other than the time lag taken into account, whether or not to perform the cancellation processing. This allows the boarding reservation to be canceled by predicting that the scheduled passenger 6 will not arrive at the boarding location in time, thus providing a boarding management system 1 with improved user friendliness. Note that another predetermined decision condition other than the time lag does not have to be a decision condition based on the activity prediction of the scheduled passenger 6 but may be changed as appropriate.

Furthermore, in the embodiment described above, the search unit 203 of the management server 2 starts, when a starting condition based on the current location of the potential user 6 is satisfied, the search processing of searching for a recommended candidate. However, the starting condition does not have to be a condition based on the current location of the potential user 6.

Alternatively, the starting condition on which the search unit 203 starts the search processing may also be a condition based on the history of the past activities of the potential user 6. When finding such a starting condition based on the history of the past activities of the potential user 6 satisfied, the search unit 203 starts the search processing. As used herein, the history of the past activities of the potential user 6 includes information about the date and time when the potential user 6 used a car 3 providing the ride sharing services in the past and/or information about the place where he or she used such a car 3. For example, when the current time falls within a time range of the day when the potential user 6 used such a car 3 providing the ride sharing services (e.g., a time range when he or she used one on his or her way home), the processing unit 20 may determine that the starting condition be satisfied and the search unit 203 may start the processing of searching for a recommended candidate. Also, when the distance from the current location of the potential user 6 to the boarding location where the potential user 6 got aboard a car 3 providing the ride sharing services becomes equal to or shorter than a predetermined starting decision distance, the processing unit 20 may determine that the starting condition be satisfied and the search unit 203 may start the processing of searching for a recommended candidate. In any case, the search unit 203 starts the search processing when a starting condition based on the history of the past activities of the potential user 6 is satisfied. This allows the search processing to be started at an effective timing when the potential user 6 is highly likely to use the moving vehicle and the potential user 6 to be notified of a recommended candidate. Compared to a situation where the search unit 203 starts the search processing when a starting condition based on the current location of the potential user 6 is satisfied, the processing load on the processing unit 20 is lightened, because the processing unit 20 of the management server 2 does not have to detect the respective current locations of a plurality of potential users 6.

Furthermore, in the embodiment described above, the second acquisition unit 202 may acquire, as a piece of the second set of information, destination information about the destination of the potential user 6, and the search unit 203 may search for a recommended candidate based on the destination information about the destination of the potential user 6. In that case, the second acquisition unit 202 may acquire, from the mobile communications device 4, the destination information, entered into the mobile communications device 4 by the potential user 6, about his or her destination. Alternatively, the second acquisition unit 202 may acquire the destination information by presuming the destination of the potential user 6 based on the current location and traveling direction, acquired from the mobile communications device 4, of the mobile communications device 4 and the past history information. This allows the search unit 203 to search for a car 3 traveling toward the destination of the potential user 6 based on the destination information about the destination of the potential user 6.

Furthermore, in the embodiment described above, the moving vehicle is implemented as a car 3. However, this is only an example and should not be construed as limiting. The moving vehicle does not have to be a car 3 but may also be any other type of vehicle such as a railway train, a ship, or an aircraft.

Furthermore, in the foregoing description of embodiments, if one of two values, being compared with each other, of time, distance, or any other physical quantity is “greater than” the other, the phrase “greater than” may also be a synonym of the phrase “equal to or greater than” that covers both a situation where these two values are equal to each other and a situation where one of the two values is greater than the other. That is to say, it is arbitrarily changeable, depending on selection of a reference value or any preset value, whether or not the phrase “greater than” covers the situation where the two values are equal to each other. Therefore, from a technical point of view, there is no difference between the phrase “greater than” and the phrase “equal to or greater than.” Similarly, the phrase “equal to or smaller than” may be a synonym of the phrase “smaller than” as well.

(Resume)

As can be seen from the foregoing description, a boarding management system (1) according to a first aspect includes at least one processor (20); and at least one memory (22) including a set of instructions that cause, when executed by the at least one processor (20), the at least one processor (20) to perform operations including: determining, based on a first set of information, a first time (T1) when a moving vehicle (3) is expected to arrive at a boarding location; determining, based on a second set of information, a second time (T2) when a scheduled passenger (6) is expected to arrive at the boarding location; determining a time lag between the first time (T1) and the second time (T2); deciding, depending on the time lag between the first time (T1) and the second time (T2), whether or not to perform cancellation processing of canceling a boarding reservation, made for the scheduled passenger (6), of the moving vehicle (3); and performing the cancellation processing of canceling the boarding reservation in accordance with a decision made by the at least one processor (20) to perform the cancellation processing.

According to this aspect, the at least one processor (20) decides, depending on the time lag between the first time (T1) and the second time (T2), whether or not to perform the cancellation processing of canceling the boarding reservation made for the scheduled passenger (6). This saves the scheduled passenger (6) the trouble to cancel his or her reservation by him- or herself, thus providing a boarding management system (1) with improved user friendliness.

In a boarding management system (1) according to a second aspect, which may be implemented in conjunction with the first aspect, the at least one processor (20) is configured to decide, further depending on a scheduled boarding time, whether or not to perform the cancellation processing. The schedule boarding time is a time when the scheduled passenger (6) is scheduled to board the moving vehicle (3).

This aspect allows the at least one processor (20) to decide, with not only the time lag between the first time (T1) and the second (T2) but also the scheduled boarding time taken into account, whether or not to perform the cancellation processing. This allows the at least one processor (20) to decide to perform the cancellation processing when the first time (T1) or the second time (T2) is delayed with respect to the scheduled boarding time, for example.

In a boarding management system (1) according to a third aspect, which may be implemented in conjunction with the first or second aspect, the operations further include comparing the time lag with a threshold value (Th1, Th2). The at least one processor (20) is configured to decide to perform the cancellation processing when the time lag is greater than the threshold value (Th1, Th2).

This aspect allows the boarding reservation to be canceled when either the moving vehicle (3) or the scheduled passenger (6) that has arrived at the boarding location earlier is expected to wait for a longer amount of time than the threshold value (Th1, Th2).

In a boarding management system (1) according to a fourth aspect, which may be implemented in conjunction with the third aspect, the operations further include: setting the threshold value (Th1, Th2).

This aspect allows for setting the threshold value (Th1, Th2) that defines an acceptable waiting time for either the moving vehicle (3) or the scheduled passenger (6) that has arrived at the boarding location earlier.

In a boarding management system (1) according to a fifth aspect, which may be implemented in conjunction with the fourth aspect, in setting the threshold value (Th1, Th2), the at least one processor (20) is configured to change the threshold value (Th1, Th2) depending on which of the moving vehicle (3) or the scheduled passenger (6) is expected to arrive at the boarding location earlier.

This aspect allows the at least one processor (20) to set the best threshold value depending on which of the moving vehicle (3) or the scheduled passenger (6) is expected to arrive at the boarding location earlier.

In a boarding management system (1) according to a sixth aspect, which may be implemented in conjunction with the fifth aspect, the threshold value includes: a first threshold value (Th1) for a first situation in which the scheduled passenger (6) is expected to arrive at the boarding location earlier than the moving vehicle (3); and a second threshold value (Th2) for a second situation in which the moving vehicle (3) is expected to arrive at the boarding location earlier than the scheduled passenger (6). The second threshold value (Th2) is smaller than the first threshold value (Th1).

This aspect allows the at least one processor (20) to set the best threshold value depending on which of the moving vehicle (3) or the scheduled passenger (6) is expected to arrive at the boarding location earlier.

In a boarding management system (1) according to a seventh aspect, which may be implemented in conjunction with any one of the first to sixth aspects, the at least one processor (20) is configured to perform the cancellation processing differently depending on which of the moving vehicle (3) or the scheduled passenger (6) is expected to arrive at the boarding location earlier.

This aspect allows the at least one processor (20) to perform the cancellation processing in an optimized way depending on which of the moving vehicle (3) or the scheduled passenger (6) is expected to arrive at the boarding location earlier.

In a boarding management system (1) according to an eighth aspect, which may be implemented in conjunction with any one of the first to seventh aspects, in determining the second time (T2), the at least one processor (20) is configured to predict the second time (T2) based on at least information about a current location of the scheduled passenger (6).

This aspect allows for predicting, based on information about the current location of the scheduled passenger (6), the second time (T2) when he or she is going to arrive at the boarding location.

A boarding management system (1) according to a ninth aspect, which may be implemented in conjunction with any one of the first to eighth aspects, further includes a communications module (21) to communicate with a mobile communications device (4) of the scheduled passenger (6). The operations further include: when the at least one processor (20) decides to perform the cancellation processing of canceling the boarding reservation made for the scheduled passenger (6), having a notification of cancellation, indicating that the boarding reservation is canceled, transmitted to the mobile communications device (4) via the communications module (21).

This aspect allows the scheduled passenger (6) to be notified of cancellation of his or her boarding reservation.

In a boarding management system (1) according to a tenth aspect, which may be implemented in conjunction with the ninth aspect, the communications module t(21) communicates with the mobile communications device (4) over a mobile communications network (5).

This aspect allows the communications module (21) to communicate with the mobile communications device (4) over the mobile communications network (5).

In a boarding management system (1) according to an eleventh aspect, which may be implemented in conjunction with the ninth or tenth aspect, the operations further include: when the at least one processor (20) decides to perform the cancellation processing of canceling the boarding reservation made for the scheduled passenger (6), having driving instruction information transmitted, via the communications module (21), to the moving vehicle (3) for which the boarding reservation is made. The driving instruction information indicates an updated route, from which schedules for boarding and deboarding the scheduled passenger (6) have been removed.

This aspect allows, when the boarding reservation made by the scheduled passenger (6) has been canceled, the driving instruction information, indicating a route updated by the cancellation of the boarding reservation, to be transmitted to the moving vehicle (3).

In a boarding management system (1) according to a twelfth aspect, which may be implemented in conjunction with any one of the first to eleventh aspects, the operations further include: when the at least one processor (20) decides to perform the cancellation processing, performing proposal processing of proposing changing the boarding location to the scheduled passenger (6).

This aspect allows for proposing changing the boarding location to the scheduled passenger (6) when the boarding reservation is canceled, thus providing a boarding management system (1) with improved user friendliness.

In a boarding management system (1) according to a thirteenth aspect, which may be implemented in conjunction with any one of the first to twelfth aspects, the moving vehicle (3) includes a plurality of moving vehicles (3). The plurality of moving vehicles (3) includes a first moving vehicle (3C) that is the moving vehicle (3) that the scheduled passenger (6) is scheduled to board and a second moving vehicle (3A) other than the first moving vehicle (3C). The operations further include: when the at least one processor (20) decides to perform the cancellation processing, performing proposal processing of proposing boarding the second moving vehicle (3A) to the scheduled passenger.

This aspect allows for proposing boarding the second moving vehicle (3A) to the scheduled passenger (6) who has had his or her boarding reservation for the first moving vehicle (3C) canceled, thus providing a boarding management system (1) with improved user friendliness.

In a boarding management system (1) according to a fourteenth aspect, which may be implemented in conjunction with any one of the first to thirteenth aspects, the operations further include: deciding, depending on another predetermined decision condition other than the time lag between the first time (T1) and the second time (T2), whether or not to perform the cancellation processing.

This aspect allows the at least one processor (20) to decide, with not only the time lag between the first time (T1) and the second (T2) but also another predetermined decision condition taken into account, whether or not to perform the cancellation processing.

A boarding management method according to a fifteenth aspect includes: determining, based on a first set of information, a first time (T1) when a moving vehicle (3) is expected to arrive at a boarding location; determining, based on a second set of information, a second time (T2) when a scheduled passenger (6) is expected to arrive at the boarding location; determining a time lag between the first time (T1) and the second time (T2); deciding, using at least one processor (20) and depending on the time lag between the first time (T1) and the second time (T2), whether or not to perform cancellation processing of canceling a boarding reservation, made for the scheduled passenger (6), of the moving vehicle (3); and performing the cancellation processing of canceling the boarding reservation in accordance with a decision made by the at least one processor (20) to perform the cancellation processing.

According to this aspect, a decision is made, depending on the time lag between the first time (T1) and the second time (T2), whether or not to perform the cancellation processing of canceling the boarding reservation made for the scheduled passenger (6). This saves the scheduled passenger (6) the trouble to cancel his or her reservation by him- or herself, thus providing improved convenience for users.

A program according to a sixteenth aspect is designed to make a computer system perform: determining, based on a first set of information, a first time (T1) when a moving vehicle (3) is expected to arrive at a boarding location; determining, based on a second set of information, a second time (T2) when a scheduled passenger (6) is expected to arrive at the boarding location; determining a time lag between the first time (T1) and the second time (T2); deciding, using at least one processor (20) and depending on the time lag between the first time (T1) and the second time (T2), whether or not to perform cancellation processing of canceling a boarding reservation, made for the scheduled passenger (6), of the moving vehicle (3); and performing the cancellation processing of canceling the boarding reservation in accordance with a decision made by the at least one processor (20) to perform the cancellation processing.

According to this aspect, a decision is made, depending on the time lag between the first time (T1) and the second time (T2), whether or not to perform the cancellation processing of canceling the boarding reservation made for the scheduled passenger (6). This saves the scheduled passenger (6) the trouble to cancel his or her reservation by him- or herself, thus providing improved convenience for users.

A system according to a seventeenth aspect includes: the boarding management system (1) described above; and at least one moving vehicle (3). The at least one moving vehicle (3) includes a communications module (31) and at least one processor (30). The communications module (31) communicates with the boarding management system (1) described above. The at least one processor (30) performs processing in accordance with driving instruction information received from the boarding management system (1) via the communications module (31).

This aspect saves the scheduled passenger (6) the trouble to cancel his or her reservation by him- or herself, thus providing improved convenience for users.

Note that these aspects are only exemplary aspects of the present disclosure. That is to say, the present disclosure has many other aspects that have not been mentioned above. For example, various configurations of the boarding management system (1) according to the embodiment and variations thereof may also be implemented as a boarding management method, a (computer) program, and a non-transitory storage medium that stores the program thereon.

Note that the constituent elements according to the second to fourteenth aspects are not essential elements of the boarding management system (1) but may be omitted as appropriate.

While various embodiments have been described herein above, it is to be appreciated that various changes in form and detail may be made without departing from the spirit and scope of the present disclosure presently or hereafter claimed.

This application claims the benefit of foreign priority to Japanese Patent Application No. 2018-066181 filed on Mar. 29, 2018, the entire contents of which are hereby incorporated by reference.

1. A boarding management system, comprising:
at least one processor; and
at least one memory including a set of instructions that cause, when executed by the at least one processor, the at least one processor to perform operations including:
determining, based on a first set of information, a first time, the first time being a time when a moving vehicle is expected to arrive at a boarding location;
determining, based on a second set of information, a second time, the second time being a time when a scheduled passenger is expected to arrive at the boarding location;
determining a time lag between the first time and the second time;
deciding, depending on the time lag between the first time and the second time, whether or not to perform cancellation processing of canceling a boarding reservation, made for the scheduled passenger, of the moving vehicle; and
performing the cancellation processing of canceling the boarding reservation in accordance with a decision made by the at least one processor to perform the cancellation processing.

2. The boarding management system of claim 1, wherein
the at least one processor is configured to decide, further depending on a scheduled boarding time, whether or not to perform the cancellation processing, the schedule boarding time being a time when the scheduled passenger is scheduled to board the moving vehicle.

3. The boarding management system of claim 2, wherein
the operations further include:
comparing the time lag with a threshold value, and
the at least one processor is configured to decide to perform the cancellation processing when the time lag is greater than the threshold value.

4. The boarding management system of claim 3, wherein the operations further include:
setting the threshold value.

5. The boarding management system of claim 4, wherein
in setting the threshold value, the at least one processor is configured to change the threshold value depending on which of the moving vehicle or the scheduled passenger is expected to arrive at the boarding location earlier.

6. The boarding management system of claim 4, wherein
the threshold value includes:
a first threshold value for a first situation in which the scheduled passenger is expected to arrive at the boarding location earlier than the moving vehicle; and
a second threshold value for a second situation in which the moving vehicle is expected to arrive at the boarding location earlier than the scheduled passenger, and
the second threshold value is smaller than the first threshold value.

7. The boarding management system of claim 1, wherein
the operations further include:
comparing the time lag with a threshold value, and
the at least one processor is configured to decide to perform the cancellation processing when the time lag is greater than the threshold value.

8. The boarding management system of claim 7, wherein
the operations further include:
setting the threshold value.

9. The boarding management system of claim 8, wherein
in setting the threshold value, the at least one processor is configured to change the threshold value depending on which of the moving vehicle or the scheduled passenger is expected to arrive at the boarding location earlier.

10. The boarding management system of claim 8, wherein
the threshold value includes:
a first threshold value for a first situation in which the scheduled passenger is expected to arrive at the boarding location earlier than the moving vehicle; and
a second threshold value for a second situation in which the moving vehicle is expected to arrive at the boarding location earlier than the scheduled passenger, and
the second threshold value is smaller than the first threshold value.

11. The boarding management system of claim 1, wherein
the at least one processor is configured to perform the cancellation processing differently depending on which of the moving vehicle or the scheduled passenger is expected to arrive at the boarding location earlier.

12. The boarding management system of claim 1, wherein
in determining the second time, the at least one processor is configured to predict the second time based on at least information about a current location of the scheduled passenger.

13. The boarding management system of claim 1, further comprising:
a communications module configured to communicate with a mobile communications device of the scheduled passenger,
wherein the operations further include:
when the at least one processor decides to perform the cancellation processing of canceling the boarding reservation made for the scheduled passenger, having a notification of cancellation, indicating that the boarding reservation is canceled, transmitted to the mobile communications device via the communications module.

14. The boarding management system of claim 13, wherein
the communications module is configured to communicate with the mobile communications device over a mobile communications network.

15. The boarding management system of claim 13, wherein
the operations further include:
when the at least one processor decides to perform the cancellation processing of canceling the boarding reservation made for the scheduled passenger, having driving instruction information transmitted, via the communications module, to the moving vehicle for which the boarding reservation is made, and
the driving instruction information indicates an updated route, from which schedules for boarding and deboarding the scheduled passenger have been removed.

16. The boarding management system of claim 1, wherein the operations further include:
when the at least one processor decides to perform the cancellation processing, performing proposal processing of proposing changing the boarding location to the scheduled passenger.

17. The boarding management system of claim 1, wherein
the moving vehicle includes a plurality of moving vehicles,
the plurality of moving vehicles includes a first moving vehicle that is the moving vehicle that the scheduled passenger is scheduled to board and a second moving vehicle other than the first moving vehicle, and
the operations further include:
when the at least one processor decides to perform the cancellation processing, performing proposal processing of proposing boarding the second moving vehicle to the scheduled passenger.

18. The boarding management system of claim 1, wherein the operations further include:
deciding, depending on another predetermined decision condition other than the time lag between the first time and the second time, whether or not to perform the cancellation processing.

19. A boarding management method, comprising
determining, based on a first set of information, a first time, the first time being a time when a moving vehicle is expected to arrive at a boarding location;
determining, based on a second set of information, a second time, the second time being a time when a scheduled passenger is expected to arrive at the boarding location;
determining a time lag between the first time and the second time;
deciding, using at least one processor and depending on the time lag between the first time and the second time, whether or not to perform cancellation processing of canceling a boarding reservation, made for the scheduled passenger, of the moving vehicle; and
performing the cancellation processing of canceling the boarding reservation in accordance with a decision made by the at least one processor to perform the cancellation processing.

20. A system, comprising:
the boarding management system of claim 1; and
at least one moving vehicle,
the at least one moving vehicle including:
a communications module configured to communicate with the boarding management system of claim 1; and
at least one processor configured to perform processing in accordance with driving instruction information received from the boarding management system via the communications module.
